(19) United States
(12) Patent Application Publication
(10) Pub. No.: US 2005/0072871 A1
(43) Pub. Date: Apr. 7, 2005

(54) Systems and methods for cracking nuts

(76) Inventor: Doyce Green, Silver Creek, GA (US)

Correspondence Address: M. Paul Qualey, Jr.;Thomas, Kayden, Horstemeyer & Risley, Suite 1750, 100 Galleria Parkway, N.W., Atlanta, GA, 30339-5948, US

(21) Appl. No.: 10/924,676

(22) Filed: Aug. 24, 2004

Related U.S. Application Data
(60) Provisional application No. 60/509,352, filed on Oct. 7, 2003.

(51) Int. Cl. B02C 19/12

(52) U.S. Cl. 241/242

(57) ABSTRACT

Nut-cracking systems are provided. A representative system comprises a housing having a rotatable crusher shaft and a feeder plate disposed therein. The crusher shaft includes a protrusion. The feeder plate is adjustable for nuts of different sizes. The crusher shaft and the feeder plate define a crusher section. A hopper provides a supply of nuts. The hopper further comprises an adjustable plate that jostles the nuts in the hopper, and tends to direct the nuts into the crusher section. Methods also are provided.

### CROSS-REFERENCE TO RELATED APPLICATION

This application claims priority to co-pending U.S. provisional application entitled “SYSTEMS AND METHODS FOR CRACKING NUTS” having Ser. No. 60/509,352, filed on Oct. 7, 2003, which is entirely incorporated herein by reference.

### TECHNICAL FIELD

The invention relates generally to cracking nuts, and more particularly to manual or motor-driven nut-cracking systems and methods suitable for cracking nuts of various sizes.

### DESCRIPTION OF THE RELATED ART

The currently available nut-cracking devices can be generally categorized into two types: manually operated apparatuses designed for household uses, and automatic machines more ready for commercial production.

Manually operated apparatuses typically are capable of only low-efficiency production, usually only cracking one nut at a time. Most of such devices also can require constant human attention, and can be dangerous to operate because shell fragments may tend to be projected during operation.

Commercial models typically are efficient in producing a high volume of cracked nuts. However, these machines can be quite sophisticated, expensive and complex for operation. These machines also may not be suitable for household uses.

The fact that nuts vary in size adds further difficulty the cracking of nuts. Because of this, an apparatus typically must be able to accommodate different sizes of nuts to avoid over cracking, i.e. damaging the nut kernels, or under-cracking the nuts.

Most nut-cracking apparatuses employ a striker mechanism that applies a sharp force to the shell of a nut in order to fracture it. Such striker mechanisms, including hammer, drum, or other types of impact members, typically are not capable of accommodating a variety of sizes of nuts. The impulse force produced by those striker mechanisms also can result in fractured nut kernels.

Other devices use one or more rollers that produce a compressive force on the shell of a nut. Although these devices avoid a sharp impact, some are still unable to accommodate various sizes of nuts. Those that are able to adjust for different sizes of nuts tend to be more complicated in design and more expensive to manufacture.

### SUMMARY

Nut-cracking systems and methods are provided. In this regard, an embodiment of a system comprises a crusher shaft and a feeder plate, between which is defined a crusher section. The crusher shaft includes a protrusion, which could be a weld bead row, for example. The crusher shaft rotates, thereby causing the protrusion to rotate. The feeder plate exhibits a curve that, with the cooperation of the protrusion, forms a narrower passage between the feeder plate and the crusher shaft at the crusher section. The feeder plate is adjustable to accommodate various sizes of nuts. A hopper is used to provide a ready supply of uncracked nuts. The hopper includes an adjustable plate that is hinged to rotate back and forth. Thus, the adjustable hopper plate jostles the nuts in the hopper, and tends to direct the nuts into the crusher section.

An embodiment of a method can be broadly summarized by the following steps: using a hopper to provide a ready supply of nuts, rotating a crusher shaft, thereby causing a protrusion to rotate, and causing an adjustable hopper plate to jostle the nuts in the hopper and to direct the nuts into a crusher section.

Other embodiments and features will or may become apparent to one with skill in the art upon examination of the following drawings and detailed description. It is intended that all such additional embodiments and features be included herein within the scope of the present invention.

### BRIEF DESCRIPTION OF THE DRAWINGS

The components in the drawings are not necessarily to scale relative to each other. Like reference numerals designate corresponding parts throughout the several views.

FIG. 1 is a schematic side view of a first embodiment of a system for cracking nuts.

FIG. 2 is a top plan view of the embodiment of FIG. 1.

FIG. 3 is a front schematic view of the embodiment of FIGS. 1 and 2.

FIG. 4 is a rear schematic view of the embodiment of FIGS. 1-3.

FIG. 5 is a schematic view of another embodiment of a system for cracking nuts.

FIG. 6 is a plan view of the embodiment of FIG. 5.

FIG. 7 is a front schematic view of the embodiment of FIGS. 5 and 6.

FIG. 8 is a right side schematic view of the embodiment of FIGS. 5-7.

### DETAILED DESCRIPTION

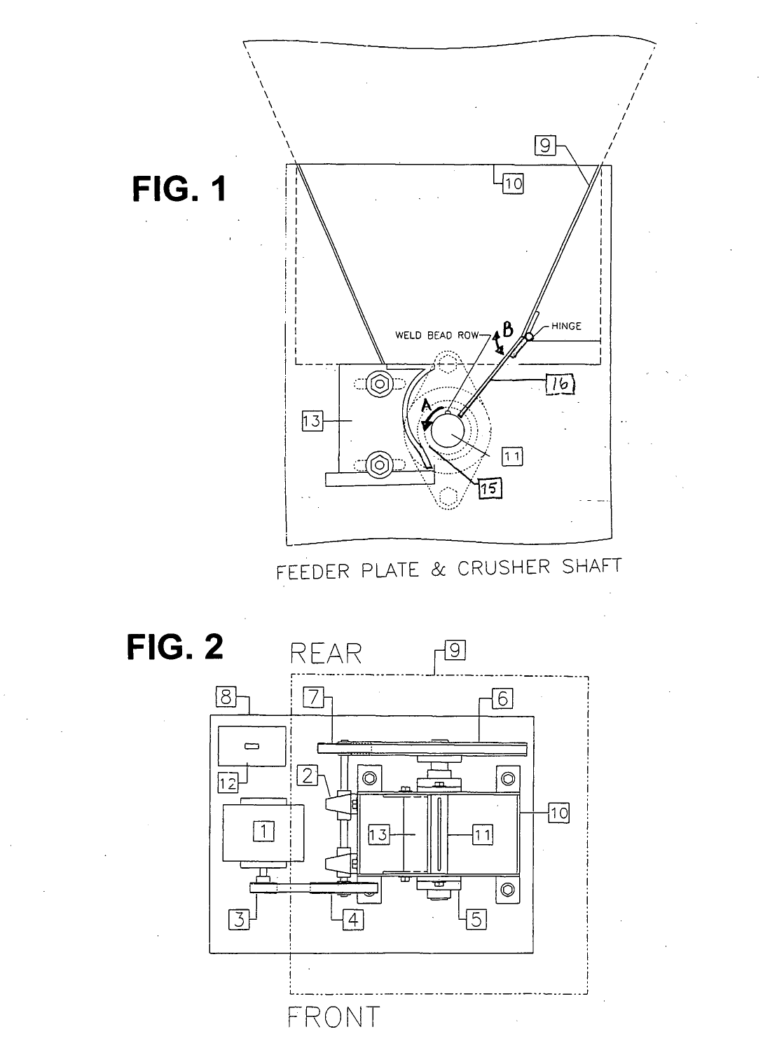

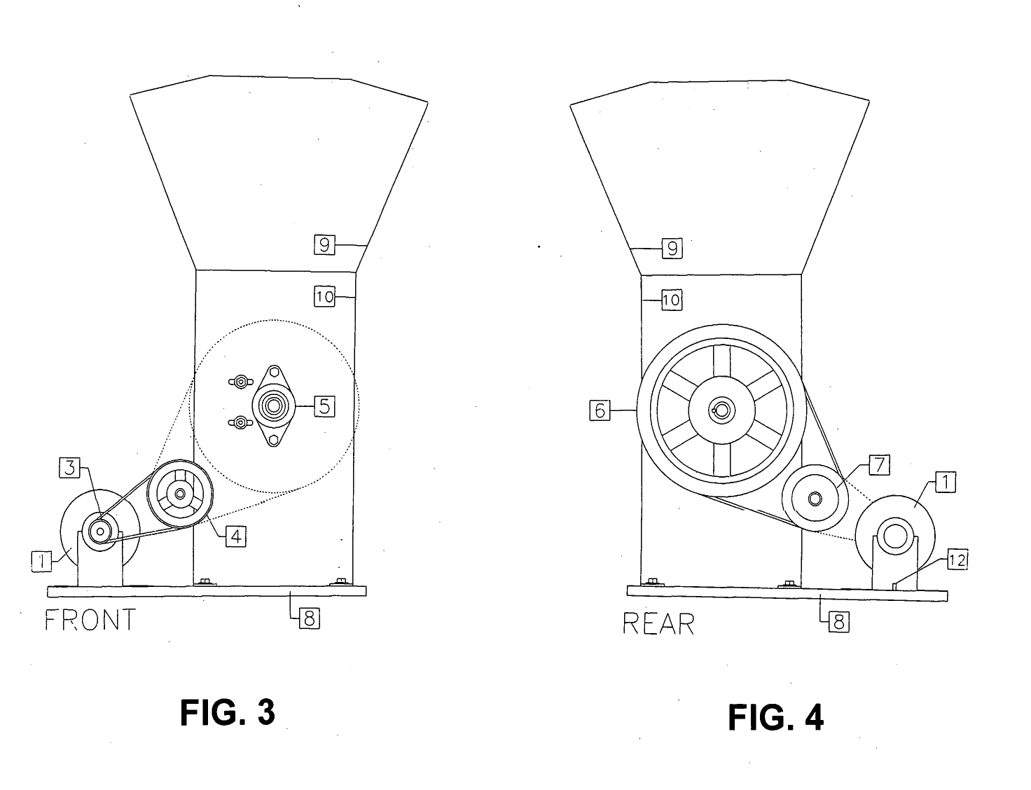

As will be described in greater detail here, systems and methods are provided that are able to crack and/or crush nuts of various sizes and shapes. In particular, two exemplary embodiments will be described, the first being a motor-driven embodiment and the second being a hand-driven embodiment. Referring now to FIGS. 1-4, the exemplary motor-driven embodiment will now be described in greater detail.

In FIGS. 1-4, this embodiment includes a hopper 9 that is used to receive one or more shelled nuts (not shown). The hopper is used to direct the nuts to a crusher section 15 that is located between a feeder plate 13 and a rotatable crusher shaft 11. The rotatable crusher shaft 11 includes a protrusion, such a weld bead row. As the crusher shaft is rotated, as indicated by arrow A, the protrusion causes the shell of a nut that is located in the crusher section and trapped between the shaft and the feeder plate to crack, thereby allowing the nut to drop below the feeder plate.

In the embodiment of FIG. 1, the feeder plate includes a complex-curve shape that provides a larger passage at the entry and exit of the feeder plate and a narrower passage between the feeder plate and the shaft at an intermediate portion, i.e., the crusher section, of the feeder plate. Also note that the hopper 9 includes an adjustable plate 16 that is hinged so that it can rotate back and forth as indicated by arrow B. Therefore, as the protrusion of the crusher shaft contacts the plate 16, continued rotation of the protrusion rotates the plate, which jostles the nuts in the hopper and tends to direct the nuts properly into the crusher section.

Rotation of the crusher shaft is facilitated by a motor 1, which can be an electric motor. Motor 1 is attached to a pulley 3, which can be a 1¾ inch diameter pulley. Pulley 3 is connected via a drive assembly to another pulley 4, which can be a 5 inch diameter pulley. A shaft connects pulley 4 to pulley 7, which can be a four inch diameter pulley. The shaft is supported by one or more shaft bearing housings 2, two of which are provided in this embodiment. Pulley 7 is attached via a drive assembly to another pulley, which can be a 12¾ inch diameter pulley. Pulley 6 is attached to the crusher shaft 11. A motor switch 12 is used to turn on and off motor 1.

In operation, the hopper 9 is filled with nuts and the motor switch 12 is turned to the on position. This energizes motor 1, which rotates pulley 3. In turn, rotation of pulley 3 rotates pulleys 4 and 7, which in turn rotates pulley 6. As mentioned before, pulley 6 rotates the crusher shaft 11, which causes the protrusion to rotate. As nuts are directed into the crusher section 15, motion of the nuts through that section typically is halted until the protrusion crushes the nuts between the feeder plate 13 and the crusher shaft. This typically causes the shells of the nuts to crack and possibly separate from the nuts. Once a nut shell has cracked, the nut and associated shell typically can pass from the crusher section for collection. Note that the feeder plate can be adjusted to accommodate various sizes of nuts.

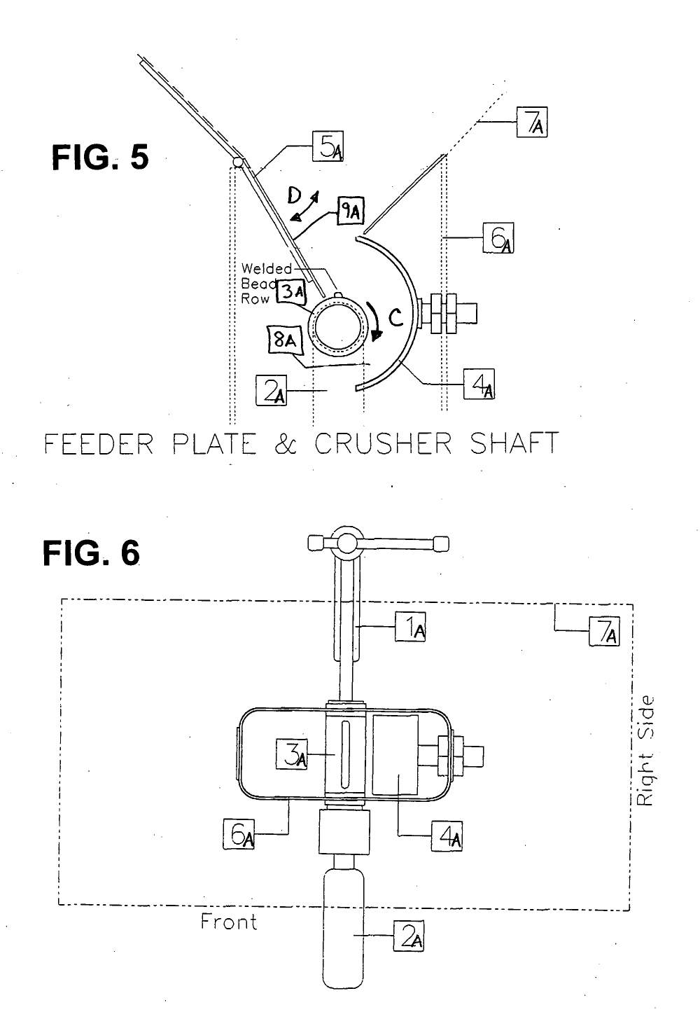

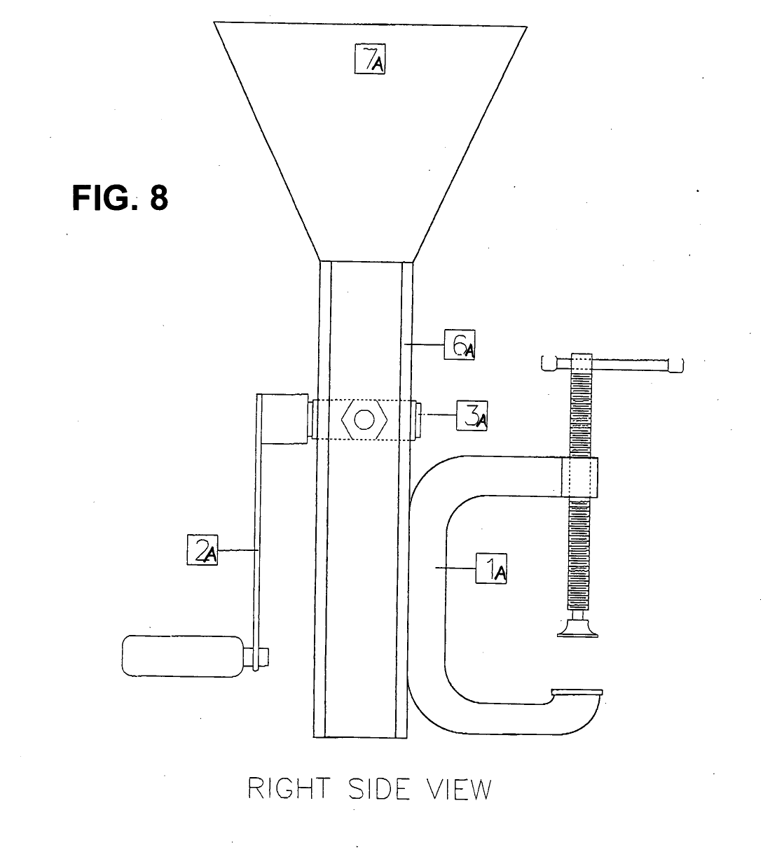

Reference will now be made to FIGS. 5-8, which depict an exemplary hand-driven embodiment of a system for cracking nuts. As shown in FIGS. 5-8, this embodiment includes a hopper 7A that is used to receive one or more shelled nuts (not shown). The hopper is used to direct the nuts to a crusher section 8A that is located between a feeder plate 4A and a rotatable crusher shaft 3A. The rotatable crusher shaft includes a protrusion, such as a weld bead row. As the crusher shaft is rotated, as indicated by arrow A, the protrusion causes the shell of a nut that is located in the crusher section and trapped between the shaft and the feeder plate to crack, thereby allowing the nut to drop below the feeder plate. In the embodiment of FIG. 5, the feeder plate exhibits a curve of a fixed radius, with the crusher shaft 3A being located off-center with respect to the center of the curve of the feeder plate. In other embodiments, the feeder plate can include a complex curve shape that provides a larger passage at the entry and exit of the feeder plate and a narrower passage between the feeder plate and the shaft at an intermediate portion, i.e., the crusher section, of the feeder plate. Also note that the hopper 7A includes an adjustable hopper plate 9A that is hinged so that it can rotate back and forth as indicated by arrow D. Therefore, as the protrusion of the crusher shaft contacts the plate 9A, continued rotation of the protrusion rotates the plate, which jostles the nuts in the hopper and tends to direct the nuts properly into the crusher section.

Rotation of the crusher shaft is facilitated by a hand crank 2A that is attached to the shaft. Thus, rotation of the hand crank rotates the shaft. A clamp, such as a C clamp 1A, is provided to anchor the system to a table or other structure so that the system can be supported during operation.

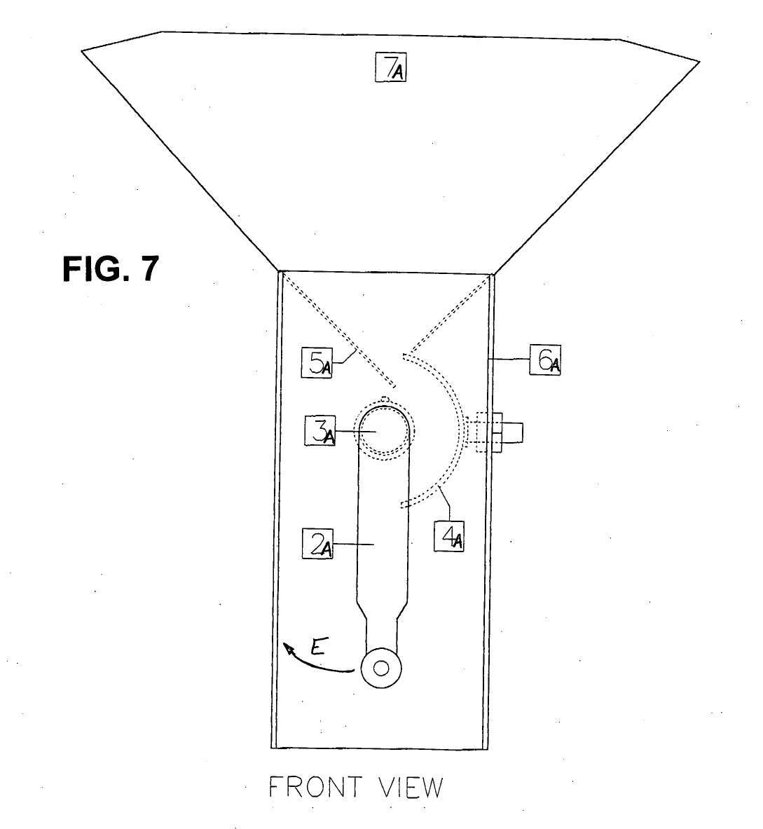

In operation, the hopper 7A is filled with nuts and the hand crank is rotated, such as indicated by arrow E of FIG. 7. Rotation of the crank rotates the crusher shaft 3A, which causes the protrusion to rotate. As nuts are directed into the crusher section 8A, motion of the nuts through that section typically is halted until the protrusion crushes the nuts between the feeder plate 4A and the crusher shaft. This typically causes the shells of the nuts to crack and possibly separate from the nuts. Once a nut shell has cracked, the nut and associated shell typically can pass from the crusher section for collection. Note that the feeder plate can be adjusted to accommodate various sizes of nuts.

The present invention potentially provides numerous advantages, a few of which are delineated hereafter as merely examples. Note that the invention provides for multiple embodiments, some of which may exhibit one or more, but not necessarily all, of the advantages described. By way of example, some embodiments can be simple in design, user friendly, reliable and efficient in operation, and comparatively inexpensive to manufacture. Also, cracking of the nuts within the apparatus housing can potentially reduce the problem of projected nut fragments.

It should be emphasized that many variations and modifications may be made to the above-described embodiments. All such modifications and variations are intended to be included herein within the scope of this disclosure and protected by the following claims.

1. A nut-cracking system, comprising:
a housing;
a crusher section disposed within the housing, wherein said crusher section is defined by
a crusher shaft and a feeder plate; and
a hopper having a bottom opening disposed adjacent the crusher section.

2. The system of claim 1, wherein the crusher shaft is configured to receive a rotary power input.

3. The system of claim 2, wherein the rotary power input is manual.

4. The system of claim 3, wherein the rotary power input is a hand crank attached to the crusher shaft.

5. The system of claim 2, wherein the rotary power input is electrical power.

6. The system of claim 1, wherein the crusher shaft further comprises a protrusion.

7. The system of claim 1, wherein the feeder plate is adjustable for nuts of various sizes.

8. The system of claim 1, wherein the feeder plate has a greater radius of curvature than the crusher shaft.

9. The system of claim 1, wherein the crusher shaft and the feeder plate are positioned such that a gap is formed therebetween.

10. The system of claim 1, wherein said gap is narrower at an intermediate portion than at an entry and an exit of the gap.

11. The system of claim 10, wherein said intermediate portion is located at the crusher section.

12. The system of claim 1, wherein the hopper further comprises an adjustable hopper plate.

13. The system of claim 12, wherein the adjustable hopper plate is hinged such that the adjustable hopper plate rotates back and forth to jostle the nuts for entry into the crusher section.

14. The system of claim 1, wherein the housing is supported by a base member.

15. The system of claim 1, wherein the housing is supported by a clamp.

16. A nut-cracking system, comprising:
adjusting means for accommodating nuts of various sizes;
directing means for guiding nuts into a crusher section.

17. The system of claim 16, wherein said adjusting means is a feeder plate.

18. The system of claim 16, wherein said directing means is an adjustable hopper plate.

19. A nut-cracking method, comprising the steps of:
a) storing nuts in a hopper;
b) rotating a crusher shaft, thereby causing a protrusion to rotate;
c) jostling the nuts in the hopper with an adjustable hopper plate to direct the nuts toward the crusher shaft.

20. The method of claim 19, further comprising the step of adjusting a feeder plate so as to accommodate various sizes of nuts.
